(19) United States
(12) Patent Application Publication
(10) Pub. No.: US 2015/0170226 A1
(43) Pub. Date: Jun. 18, 2015

(54) VIRTUAL CHARITABLE EVENT

(71) Applicant: eBay Inc., San Jose, CA (US)

(72) Inventors: Krystal Rose Higgins, Campbell, CA (US); Selina Lam, Castro Valley, CA (US)

(21) Appl. No.: 14/522,112

(22) Filed: Oct. 23, 2014

Related U.S. Application Data
(60) Provisional application No. 61/917,258, filed on Dec. 17, 2013.

(51) Int. Cl. G06Q 30/02

(52) U.S. Cl. CPC G06Q 30/0279

(57) ABSTRACT

In an example embodiment, an indication of a donation amount and a goal of a virtual charitable event are received. Then the donation amount is broken down into a plurality of donation credits. The donation credits are then placed in a queue. Progress information is then received from a plurality of mobile devices, the progress information from each mobile device describing progress made towards the goal of the virtual charitable event from a user of the mobile device. The donation credits are then applied from the queue to a plurality of participants in the virtual charitable event based on the progress information received from the plurality of mobile devices.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### CROSS-REFERENCE TO RELATED APPLICATION

This application is a Non-Provisional of and claims the benefit of priority under 35 U.S.C. §119(e) from U.S. Provisional Application Ser. No. 61/917,258, entitled “VIRTUAL WALKATHON WITH DONATIONS PLATFORM,” filed on Dec. 17, 2013 which is hereby incorporated by reference herein in its entirety.

### TECHNICAL FIELD

This application relates generally to charitable donation platforms. More particularly, this application relates to a virtual charitable event with an associated donation platform.

### BACKGROUND

Walkathons are charity events where individuals walk (or in related events, run, bike or swim) in order to raise money for charity. Typically participants try to get sponsors, such as friends, relatives, businesses to agree to donate a set amount for a given distance traveled, such as $1 a mile, up to an agreed maximum. Walkathons, and similar events, however, are limited time engagements that require a time and/or location commitment that may be inconvenient for the participants. Additionally, each participant's network of potential donors can be easily exhausted by a single event, making additional donations difficult to obtain. Furthermore, for smaller charities, the overhead of hosting a physical walkathon or similar event can be a large deterrent.

### BRIEF DESCRIPTION OF THE FIGURES

Some embodiments are illustrated by way of example and not limitation in the figures of the accompanying drawings, in which like reference numbers indicate similar elements and in which:

FIG. 1 is a network diagram depicting a client-server system, within which one example embodiment may be deployed.

FIG. 2 is a block diagram illustrating marketplace and payment applications that, in one example embodiment, are provided as part of application server(s) in the networked system.

FIG. 3 is a block diagram illustrating a system in accordance with an example embodiment.

FIG. 4 is a screen capture illustrating an example of an introduction screen displayed in a user interface on a mobile device in accordance with an example embodiment.

FIG. 5 is a screen capture illustrating an example of a charity screen displayed in a user interface on a mobile device in accordance with an example embodiment.

FIG. 6 is a screen capture illustrating an example of a pace screen displayed in a user interface on a mobile device in accordance with an example embodiment.

FIG. 7 is a screen capture illustrating another example of a pace screen displayed in a user interface on a mobile device in accordance with an example embodiment.

FIG. 8 is a flow diagram illustrating a method in accordance with an example embodiment.

FIG. 9 is a block diagram illustrating a mobile device, according to an example embodiment.

FIG. 10 is a block diagram of machine in the example form of a computer system within which instructions may be executed for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In an example embodiment, a virtual walkathon is provided with a donation platform that addresses many of the pain points found in real-world walkathons. An automated system can be created that allows anyone to make a flat dollar donation to the charity of their choice. A donation queue manager within the donation platform allows the system to distribute credits for the donation in a number of different ways to potential participants in the virtual walkathon. Participants may then walk, run, bike, swim or perform some other activity tied to the charitable donation at their leisure. A mobile and/or wearable tracking device, either standalone or integrated within a mobile device such as a smartphone, can then track their progress. The participant may then “earn” portions, or credits, of the donor's flat donation over time/goals. This may include, for example, using an accelerometer to measure steps taken and a global positioning system (GPS) module to track distance traveled.

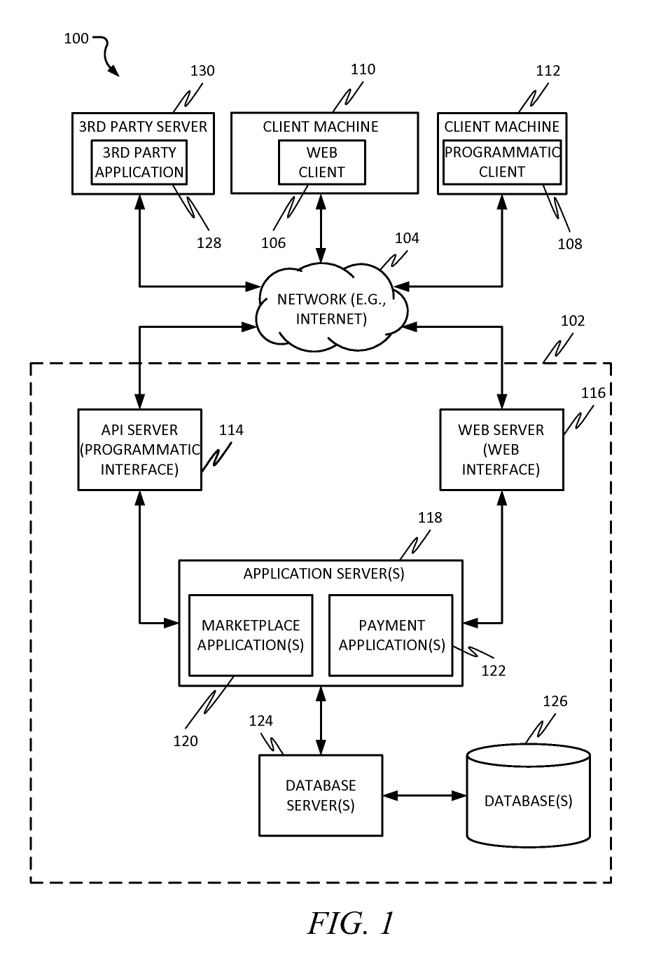

As will be described in more detail later, information from an ecommerce marketpace and/or marketplace application can be utilized by a donations queue manager in best determining how to distribute donations and/or donation information/credit. FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)), to one or more clients. FIG. 1 illustrates, for example, a web client 106 (e.g., a browser, such as the Internet Explorer browser developed by Microsoft Corporation of Redmond, Wash. State) and a programmatic client 108 executing on respective devices 110 and 112.

An Application Program Interface (API) server 114 and a web server 116 are coupled to, and provide programmatic and web interfaces respectively to, one or more application server(s) 118. The application server(s) 118 hosts one or more marketplace application(s) 120 and payment application(s) 122. The application server(s) 118 is, in turn, shown to be coupled to one or more database server(s) 124 that facilitate access to one or more database(s) 126.

The marketplace application(s) 120 may provide a number of marketplace functions and services to users who access the networked system 102. The payment application(s) 122 may likewise provide a number of payment services and functions to users. The payment application(s) 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace application(s) 120. While the marketplace and payment applications 120 and 122 are shown in FIG. 1 to both form part of the networked system 102, it will be appreciated that, in alternative embodiments, the payment application(s) 122 may form part of a payment service that is separate and distinct from the networked system 102.

Further, while the client-server system 100 shown in FIG. 1 employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

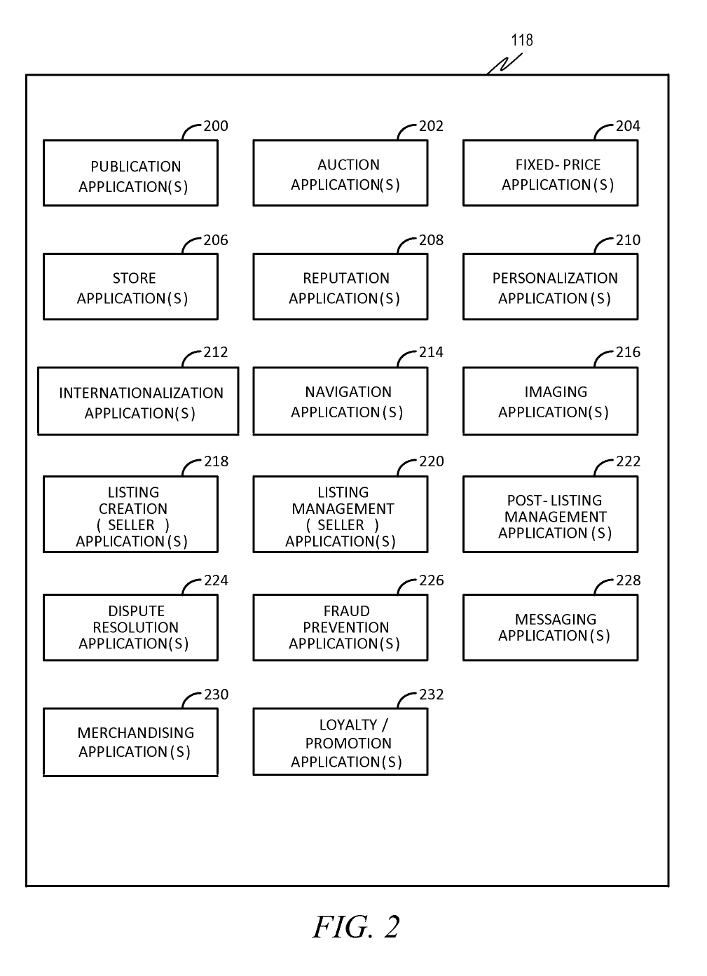

FIG. 2 is a block diagram illustrating marketplace and payment applications 120 and 122 that, in one example embodiment, are provided as part of application server(s) 118 in the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more database(s) 126 via the database server(s) 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions, etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information by the networked system 102) according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks 104.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

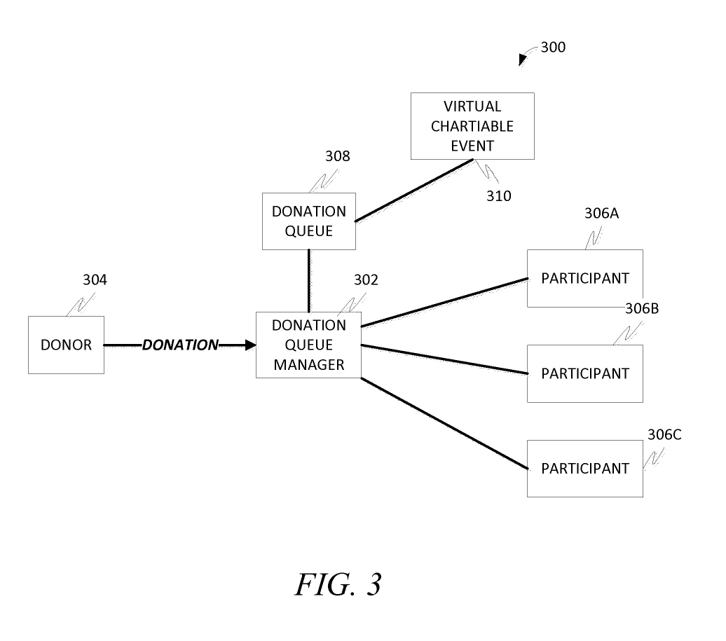

FIG. 3 is a block diagram illustrating a system 300 in accordance with an example embodiment. In some example embodiments, this system 300 may communicate with the systems and/or applications of FIGS. 1-2 in order to better distribute donations and credits for donations. A donation queue manager 302 may receive donation information from donor 304. The donation information may include, for example, details about the donor, the amount of the donation, and any conditions on the donation. Conditions may include rates at which the donation is to be distributed (e.g., how much for each step, stage, or time spent in the virtual walkathon or other charitable event, etc.), desired recipients of donation credit (e.g., donation credit is available to teenagers only, only people within a particular city limit can receive donation credit, only employees of a particular company, etc.). The donation queue manager 302 may then utilize information about participants 306A, 306B, 306C to break up the donation into multiple credits and prioritize the credits in a donation queue 308. Alternatively, the donation queue manager 302 may place the credits in the donation queue 308 and then utilize the information about participants 306A, 306B, 306C to determine when to assign a donation credit at the head of the donation queue 308 to a participant 306A, 306B, 306C. This will be described in more detail below. The donation queue 308 may be accessed by a virtual charitable event 310 such as a virtual walkathon when determining how to apply the parts of the donation and to whom to give credit. The information about the participants may include, for example, demographic information, exercise history, prior charitable event participation, weight, etc.

The donation queue manager 302 can use a number of different metrics to determine how to best distribute the donation credits. This may include participant metrics, such as how often they engage, how often they meet their goals, total number of steps, total amount raised, etc. In this manner, participants can be further motivated to meet their virtual walkathon goals because it may mean they are more likely to be at the head of the queue.

In such an example embodiment, the algorithm used by the donation queue manager 302 to analyze the different metrics and determine how to distribute the donations may proceed as follows. First, the donation queue manager may identify one or more key attributes of participants. This may include one or more of the conditions received from the donor 304. For example, one key attribute may be that the participant be an employee of a particular company. Some of the key attributes, however, may be selected without regard for the wishes of the donor 304. For example, the donation queue manager 302 may be programmed to have a bias towards distributing the donation credits to participants who need exercise. Thus, attributes such as weight, prior charitable, event participation, exercise history, etc. may be key attributes. Once the key attributes are selected, the key attributes can be individually weighted, allowing certain key attributes to gain more importance than others. Information about the participants that is relevant to the key attributes may be gathered and a score for each participant can be generated based on the information about the participant and the weighted key factors. The user with the “best” score may then be eligible to receive the first set of credits in the donation queue, followed by the user with the “second best” score, and so on.

In order to prevent one participant from monopolizing all the available donation credits, a maximum level of credits may be established for each participant, or some other type of restriction or mediation of the number of donations credits that can be applied to a particular participant may be established. This maximum level may either be a lifetime level, a per-charitable event level, or a time-based level (e.g., no more than X credits per day).

In another example embodiment, a pool of pledges may be created by employers or other individuals who put out a “bounty” towards someone or a group of people to achieve fitness goals. For example, a company may have a goal to reduce its insurance costs, so it may pool money/benefits to be doled out according to goals achieved using a fitness tracker.

In another example embodiment, a pool of pledge money may be created by a company or group of individuals that are sponsoring or participating in a contest. For example, a large corporation may wish to create some hype before a Super Bowl game. The credits for the pooled money may get doled out over the course of the contest timeframe to participants who achieve an appropriate number of steps or other trackable goal using a fitness tracking device.

As described briefly above, the donation queue manager 302 may automatically (or at least semi-automatically) distribute donations among a number of participants or potential participants. The donation queue manager 302 may decide how best to distribute the donations based on one or more factors. There may be many different factors that the donation queue manager 302 may select from, some of which are mentioned here. A first type of factor is participant involvement. This may involve, for example, distributing donations in a way that favors participants who are most likely to participate. As an example, the system 300 could track how often a participant exercises, total number of miles traversed in previous participations, total amount of money raised in previous participations, etc. and weight the distributions of a donation towards participants who maximize such metrics. This provides incentive for people who have participated in the past to keep participating, and creates a sort of “gamification” of the virtual walkathon, where people are incentivized to work even harder for the thrill of continuing a cycle of getting additional donations.

In another example, some or all of the donations may be weighted the other way—namely towards participants who are least likely to participate. This may include favoring, for example, new participants who have no track record of success and are most likely to drop out unless initial success is achieved. This may also including favoring, for example, participants who have dropped in participation, such as those who haven't participated for a fixed amount of time or whose participation levels (perhaps measured by money raised, steps walked, etc.) have dropped recently. This is intended to incentivize participants who may have been tiring of the virtual walkathon aspects to reengage.

Another type of factor that may be utilized by the donation queue manager 302 may be how closely the participants match the desired participants as defined by the donor. In such instances, participant traits that are important to a specific donor may be determined, either by inference or by direct input from the donor. The donation queue manager 302 may then favor providing donations to participants with matching traits. These traits may be important to a donor for many reasons. In one example, a corporate donor may be more interested in spreading brand awareness/advertising than actually donating to charity. In such cases, the donor may wish to target donations on key demographics important to their brand/product. For example, a maker of running shoes specifically designed for women may wish to target the donation distributions to women who have track records of running a lot. As such, the donation queue manager 302 may favor participants with such traits. Alternatively, a local bakery may wish to target donation distributions to participants who are in an area surrounding the bakery's location, and participants who do not have a track record of significant participation in the virtual walkathon. In another example embodiment, the donor can specify a goal for a participant. For example, the donor may specify a number of steps needed to earn a pledge, or specify a particular type of activity (e.g., walking vs. running).

Location-based donation distribution via the donation queue manager 302 provides significant flexibility in addressing many different donor needs. In addition to targeting participants in a specific area, the donation queue manager 302 can also favor specific types of walkathons over others, for example, rather than having a general walkathon where participants are rewarded for each mile they walk, run, bike, swim, etc., no matter where such exercise takes place. Certain more specific walkathons may be established that better align with a donor's needs. For example, a store with multiple locations in a city may wish to favor participants who walk from one of those store locations to another of the store locations. This may help create brand awareness and press coverage.

In another example embodiment, social networking aspects may be integrated into the virtual walkathon and/or donation queue manager 302. This may be especially helpful in cases where the donors are individuals rather than corporations. Individual donors have typically favored donating to walkathon participants who are also existing friends or family, over “anonymously” donating to participants they do not know. In some example embodiments, the donor may be linked in a social network to the virtual walkathon participants to whom their donations have been distributed. This not only has the effect of increasing participation by donors, but also could lead to increased social aspects of the virtual walkathon, where the system can be used as a mechanism to make new friends.

In another example embodiment, the donation queue 308 and a donation platform may be integrated within an online marketplace and/or payment system to facilitate additional features. When integrated with a payment system, donation opportunities may be presented to users from within the payment system, making it much easier for users to donate and increasing likely participation. The online marketplace may also be used as a platform for making donations as well. Additionally, information from either the online marketplace or the payment system may be utilized in the donation queue manager 302. For example, past transaction history may be examined for participants and the donation queue manager 302 may utilize this information to better match participants with donor goals. The transaction history may indicate, for example, a large number of purchases of running gear. This may be used by the donation queue manager 302 as information relevant to one or more of the key attributes described earlier, such as an indication that the user exercises heavily.

Additionally, the information flow may operate in the opposite direction as well. For example, information about participation in virtual walkathons may be used to better recommend products for sale on the online marketplace. For example, if the virtual walkathon results for a particular user indicate she runs quite a bit, the system may utilize this information to recommend running shoes in the online marketplace. Similarly, promotions may be provided in the payment system for purchases based on the virtual walkathon information (e.g., coupons for running shoe purchases).

In some example embodiments, participants may be able to expressly indicate which charities they would like to participate for, and then automatically be linked to donors who share such an interest in those charities. In a related example embodiment, a participant may actually be automatically presented with likely charities of interest, based on, perhaps, information from the online marketplace. For example, purchases of diabetic supplies on the online marketplace such as glucose monitors, test strips, diabetic candy, diabetic socks, etc. may make it more likely that the user is interested in participating in a virtual walkathon to benefit a charity related to diabetes than one related to some other cause.

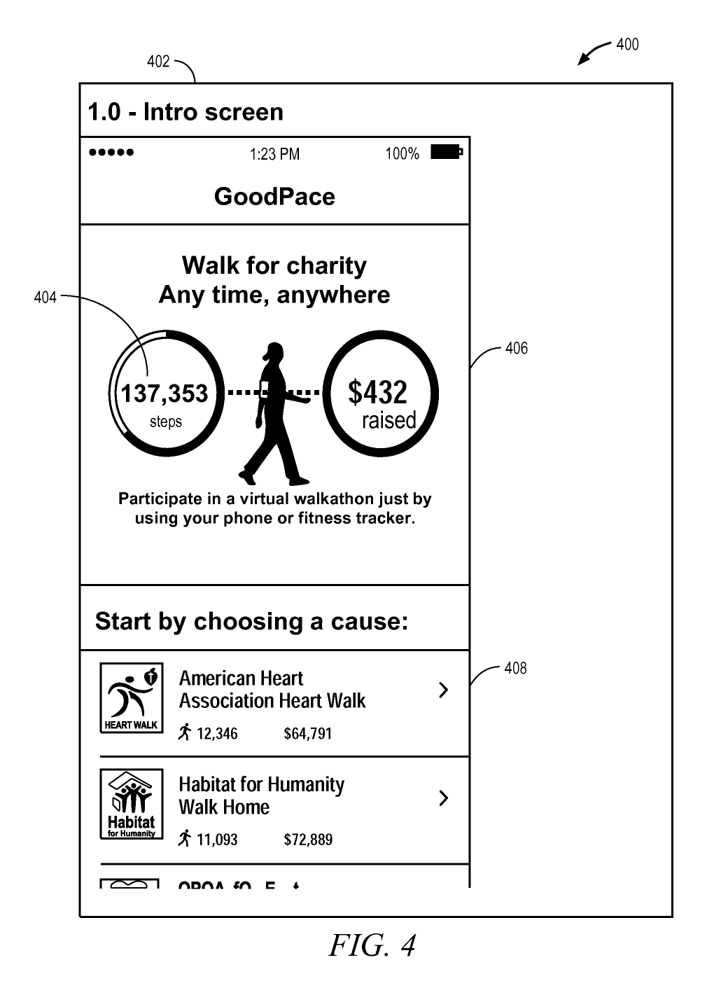

FIGS. 4-7 are screen captures illustrating examples of screens displayed in a user interface on a mobile device in accordance with an example embodiment. The mobile device may be operated by a participant in a virtual charity event. FIG. 4 is a screen capture illustrating an example of an introduction screen displayed in a user interface on a mobile device in accordance with an example embodiment. Here, the screen 400 may provide an overview 402 of the concept of participating in a virtual walkathon, including a real-time indication of the number of steps 404 tracked and donations 406 raised. It should be noted that these real-time indications may either indicate the totals for the particular user operating the mobile device, or indicate the overall total for all the participants in the virtual walkathon. In the example pictured, the total reflect totals are just for the user alone. The user may also be presented with a choice 408 of different charities to which to apply any money raised by virtue of participation in the virtual walkathon.

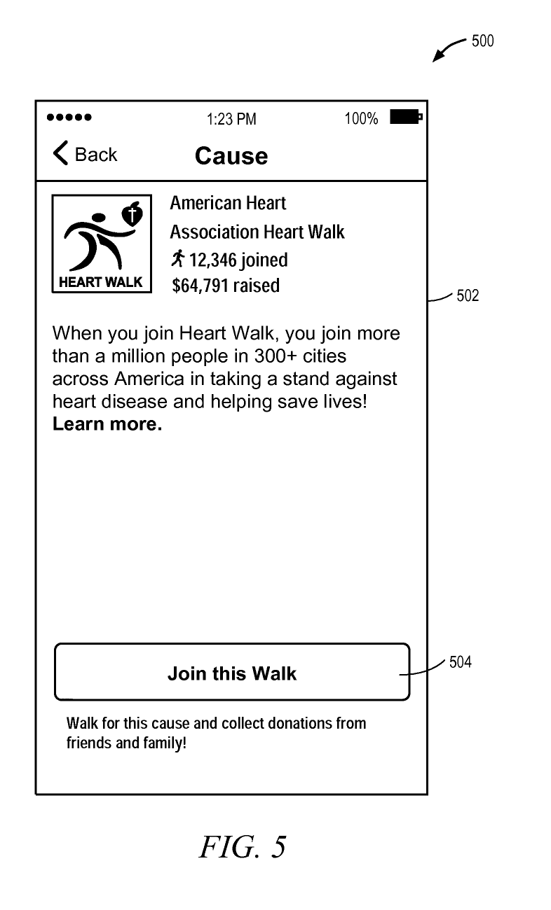

FIG. 5 is a screen capture illustrating an example of a charity screen displayed in a user interface on a mobile device in accordance with an example embodiment. The screen 500 may contain a summary 502 of the charity and a button 504 the user may select to join the virtual walkathon on behalf of the charity.

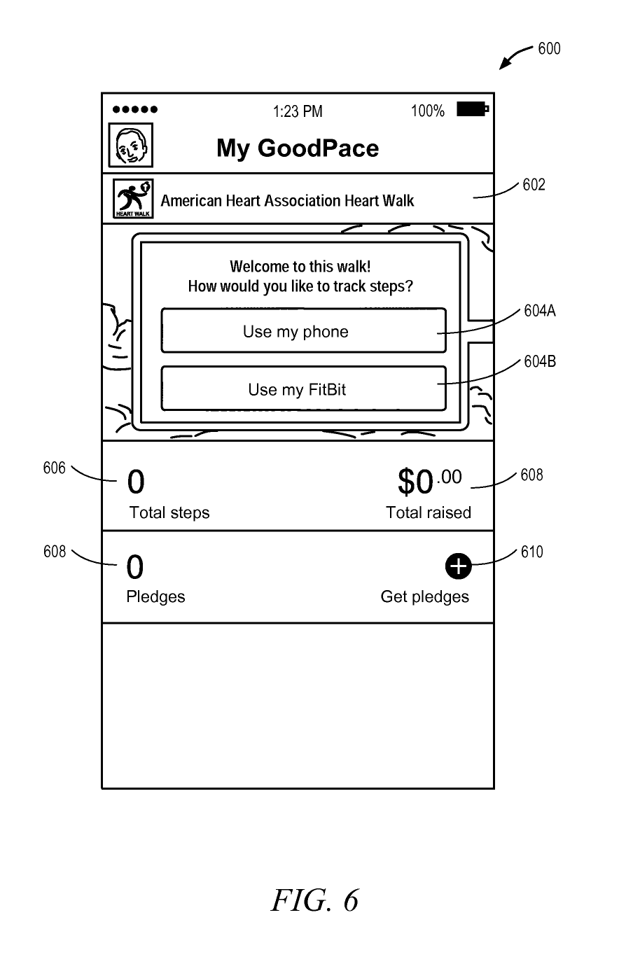

FIG. 6 is a screen capture illustrating an example of a pace screen displayed in a user interface on a mobile device in accordance with an example embodiment. The screen 600 displays the selected charity 602, as well as a plurality of buttons 604A, 604B allowing the user to select how to track the progress towards the goal of the virtual walkathon (in this case, steps). The choices available may be dynamically determined based on the possible tracking devices operated by the user. In this case, the user has a phone and a FitBit™. The buttons 604A, 604B therefore allow the user to select which of these devices to use to track steps.

Additional information is presented on the screen 600, including total steps 606, total raised 608, pledges 610 and a button 612 to obtain additional pledges. A pledge involves a third party agreeing to donate a particular amount for a portion of the overall goal obtained by the user. In the case of a virtual walkathon, the pledge is usually expressed in terms of a dollar amount per step or number of steps, although other measurements could be used (e.g., dollar amount per mile, dollar amount per leg of a predetermined route, etc.).

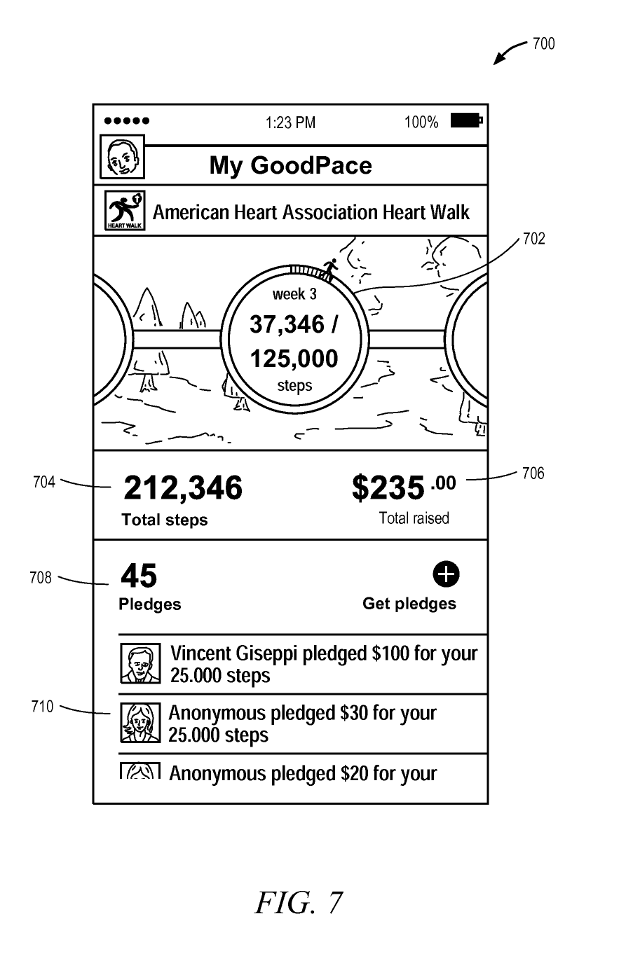

FIG. 7 is a screen capture illustrating another example of a pace screen displayed in a user interface on a mobile device in accordance with an example embodiment. Here, the user has walked a number of steps and thus the screen 700 has been updated dynamically with the current steps totals. Specifically, the screen 700 has an area 702 where current steps for the week and goal steps for the week are displayed. Additionally, information such as overall total steps 704, overall total raised 706, and number of pledges 708 are displayed. A list 710 of recent pledges may also be displayed.

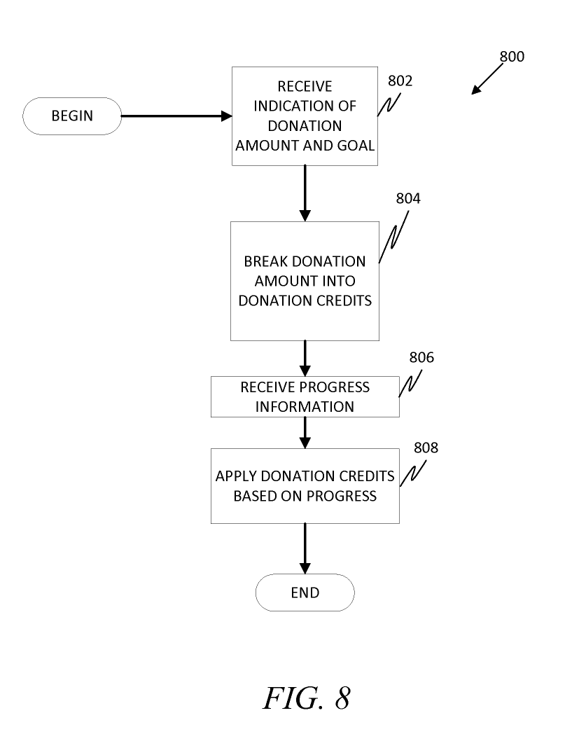

FIG. 8 is a flow diagram illustrating a method 800 in accordance with an example embodiment. At operation 802, an indication of a donation amount and a goal of a virtual charitable event may be received. At operation 804, the donation amount may be broken into a plurality of smaller donations. These smaller donations may be also known as credits. At operation 806, the donation credits may be placed in a queue. This may involve maintaining a separate data structure or entry in a data structure for each donation credit, storing information about the donation credit such as its amount and one or more weighted key attributes for distribution of the donation credit as described above. In another example embodiment, key attributes are stored in a pledge table, with each entry of the pledge table associated with a different donor. At operation 808, progress information may be received from a plurality of mobile devices, the progress information describing progress made towards the goal of the virtual charitable event from a user of the mobile device. At operation 810, the donation credits from the queue may be applied to a plurality of participants in the virtual charitable vent based on the progress information received from the plurality of mobile devices (and the pledge table, if appropriate).

### Example Mobile Device

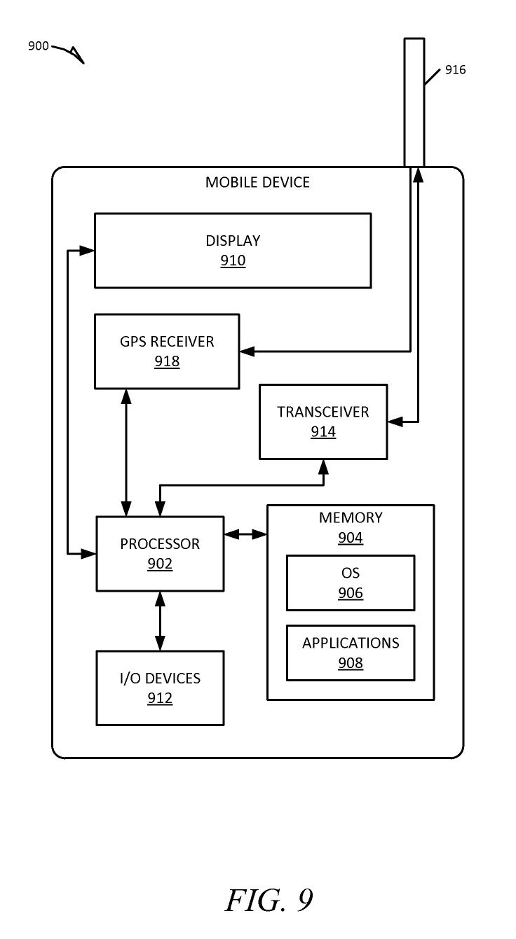

FIG. 9 is a block diagram illustrating a mobile device 900, according to an example embodiment. The mobile device 900 may include a processor 902. The processor 902 may be any of a variety of different types of commercially available processors 902 suitable for mobile devices 900 (for example, an XScale architecture microprocessor, a microprocessor without interlocked pipeline stages (MIPS) architecture processor, or another type of processor 902). A memory 904, such as a random access memory (RAM), a flash memory, or other type of memory, is typically accessible to the processor 902. The memory 904 may be adapted to store an operating system (OS) 906, as well as application programs 908, such as a mobile location enabled application that may provide location-based services to a user. The processor 902 may be coupled, either directly or via appropriate intermediary hardware, to a display 910 and to one or more input/output (I/O) devices 912, such as a keypad, a touch panel sensor, a microphone, and the like. Similarly, in some embodiments, the processor 902 may be coupled to a transceiver 914 that interfaces with an antenna 916. The transceiver 914 may be configured to both transmit and receive cellular network signals, wireless data signals, or other types of signals via the antenna 916, depending on the nature of the mobile device 900. Further, in some configurations, a GPS receiver 918 may also make use of the antenna 916 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 902 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor 902 or other programmable processor 902) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor 902 configured using software, the general-purpose processor 902 may be configured as respective different hardware-implemented modules at different times. Software may accordingly configure a processor 902, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors 902 that are temporarily configured (e.g., by software) or permanently configured to perform the relevant operations. Whether temporarily or permanently configured, such processors 902 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 902 or processor-implemented modules. The performance of certain of the operations may be distributed among the one or more processors 902, not only residing within a single machine, but deployed across a number of machines. In some example embodiments, the processor 902 or processors 902 may be located in a single location (e.g., within a home environment, an office environment or as a server farm), while in other embodiments the processors 902 may be distributed across a number of locations.

The one or more processors 902 may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 902, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 902 executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

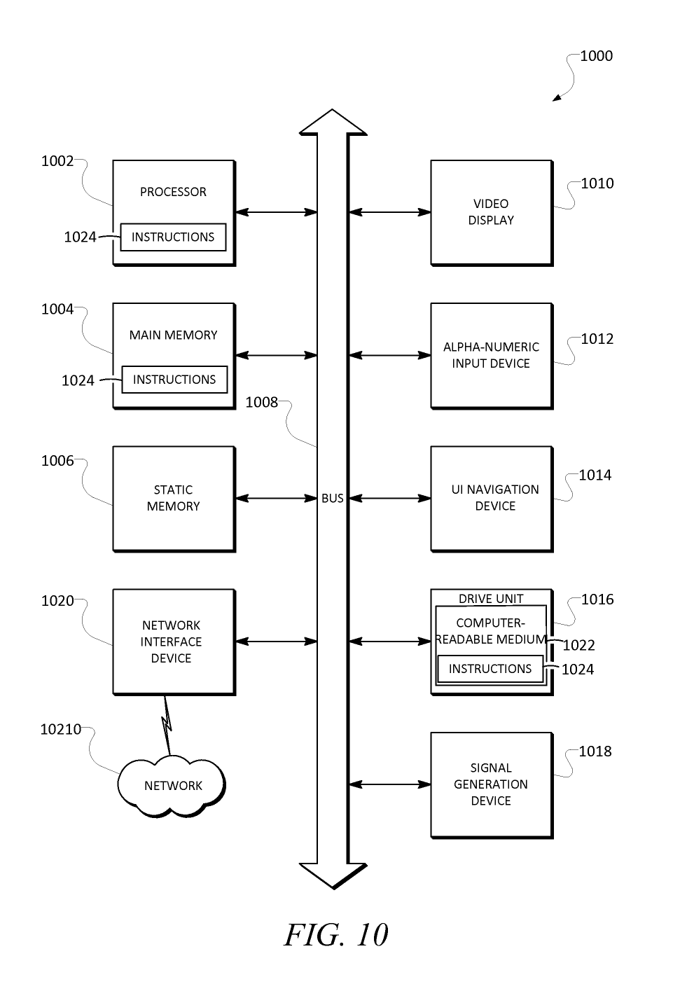

FIG. 10 is a block diagram of machine in the example form of a computer system 1000 within which instructions 1024 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions 1024 and data structures (e.g., software) embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media 1022.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding or carrying instructions 1024 for execution by the machine and that cause the machine to perform any one or more of the methodologies of the present disclosure or that is capable of storing, encoding or carrying data structures utilized by or associated with such instructions 1024. The term “machine-readable medium” shall accordingly be taken to include, but not be limited to, solid-state memories, and optical and magnetic media. Specific examples of machine-readable media 1022 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 1024 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. An apparatus comprising:
a donations queue manager configured to:
receive an indication of a donation amount and a goal of a virtual charitable event;
break the donation amount into a plurality of smaller donations;
assign a donation credit to each of the plurality of smaller donations;
place the plurality of donation credits in a donation queue;
receive progress information from a plurality of mobile devices, the progress information from each mobile device describing progress made towards the goal of the virtual charitable event from a user of the mobile device;
compare the progress information to a pledge table; and
apply the donation credits from the queue to a plurality of participants in the virtual charitable event based on the progress information received from the plurality of mobile devices and the comparison to the pledge table.

2. The apparatus of claim 1, wherein the donation queue manager is further configured to:
obtain locations for each of the plurality of mobile devices; and
wherein the applying the smaller donations is based on the locations for each of the plurality of mobile devices.

3. The apparatus of claim 1, wherein the donation queue manager is further configured to communicate with an online marketplace and payment system to obtain donations.

4. The apparatus of claim 3, wherein the donation queue manager is further configured to communicate with the online marketplace and payment system to obtain information about the plurality of participants in the virtual charitable event for use in the applying the smaller donations from the queue.

5. The apparatus of claim 4, wherein the donation queue manager is further configured to present to each user of the plurality of mobile devices a selection of charities to which progress will be applied, the selection of charities determined based on information about each user from the online marketplace and payment system.

6. A method comprising:
receiving an indication of a donation amount and a goal of a virtual charitable event;
breaking the donation amount into a plurality of donation credits;
identifying one or more key attributes of each of the plurality of donation credits;
placing the donation credits in a queue, along with the one or more key attributes of each of the donation credits;
receiving progress information from a plurality of mobile devices, the progress information from each mobile device describing progress made towards the goal of the virtual charitable event from a user of the mobile device; and
applying the donation credits from the queue to a plurality of participants in the virtual charitable event based on the progress information received from the plurality of mobile devices and based on the one or more key attributes for each donation credit.

7. The method of claim 6, wherein the progress information includes a distance traveled by a user of a mobile device.

8. The method of claim 7, wherein the distance traveled is measured by the mobile device.

9. The method of claim 7, wherein the distance traveled is measured by a sensor external to the mobile device.

10. The method of claim 6, wherein the applying the smaller donations is performed in a manner that maximizes participant involvement.

11. The method of claim 10, wherein the applying is performed by favoring participants who exercise regularly.

12. The method of claim 10, wherein the applying is performed by favoring participants who do not exercise regularly.

13. The method of claim 6, wherein the virtual charitable event is a virtual walkathon.

14. A non-transitory computer-readable storage medium comprising instructions that, when executed by at least one processor of a machine, cause the machine to perform the operations of:
receiving an indication of a donation amount and a goal of a virtual charitable event;
breaking the donation amount into a plurality of donation credits;
identifying one or more key attributes of each of the plurality of donation credits;
placing the donation credits in a queue, along with the one or more key attributes of each of the donation credits;
receiving progress information from a plurality of mobile devices, the progress information from each mobile device describing progress made towards the goal of the virtual charitable event from a user of the mobile device; and
applying the donation credits from the queue to a plurality of participants in the virtual charitable event based on the progress information received from the plurality of mobile devices and based on the one or more key attributes for each donation credit.

15. The non-transitory computer-readable storage medium of claim 14, wherein the progress information includes a distance traveled by a user of a mobile device.

16. The non-transitory computer-readable storage medium of claim 15, wherein the distance traveled is measured by the mobile device.

17. The non-transitory computer-readable storage medium of claim 15, wherein the distance traveled is measured by a sensor external to the mobile device.

18. The non-transitory computer-readable storage medium of claim 14, wherein the applying the smaller donations is performed in a manner that maximizes participant involvement.

19. The non-transitory computer-readable storage medium of claim 18, wherein the applying is performed by favoring participants who exercise regularly.

20. The non-transitory computer-readable storage medium of claim 18, wherein the applying is performed by favoring participants who do not exercise regularly.
